(19) United States
(12) Patent Application Publication
(10) Pub. No.: US 2003/0220833 A1
(43) Pub. Date: Nov. 27, 2003

(54) On-line promotion method

(76) Inventor: Theodore Benderev, Laguna Hills, CA (US)

Correspondence Address: Matthew A. Newboles, STETINA BRUNDA GARRED & BRUCKER, SUITE 250, 75 ENTERPRISE, ALISO VIEJO, CA, 92656, US

(21) Appl. No.: 10/152,230

(22) Filed: May 21, 2002

(51) Int. Cl. G06F 17/60

(52) U.S. Cl. 705/14

(57) ABSTRACT

On-line advertising methods are disclosed. A central web site is maintained that is accessible to potential consumers and provides information and/or entertainment related to a particular subject and/or targeted group of consumers. As consumers peruse content data of such web site, the consumer is ultimately provided with an obligation to provide criteria indicative of the consumer, and in particular, demographic data such as the geographic area where the consumer conducts business. In response to the data provided by the consumer, advertising and promotional material of a specific vendor or service provider is brought to the consumer's attention. The on-line methods are particularly well suited for health care workers, namely physicians in the development of their medical practices.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The use of the Internet as an advertising and promotional medium is well known. In this regard, millions of web sites have been and continue to be operated that include advertising content, such as banner advertisements and the like that is intended to reach as wide a segment of the population as is possible in the hopes that at least some small portion thereof will take notice and proceed to enter into a transaction with a given seller or, at a minimum, make a further inquiry from the seller.

Along these lines, the Internet offers several advantages over conventional advertising and marketing practices. For example, the creation and maintenance of a web site typically involves far less expense than commercials aired through traditional mediums such as television or radio, which require substantial production and layout costs. Advertising on the Internet further has advantages over the distribution of printed advertising materials, which have the drawback of reaching limited segments of the population, as well as postal fees and printing costs. Moreover, unlike traditional advertising mediums, the use of on-line advertising enables advertising content and the like to be continuously active and capable of being viewed twenty four hours a day, and as such, is available at the convenience of prospective customers whenever the same are actively searching for a particular product or service on-line.

Despite such advantages, however, on-line advertising suffers from several drawbacks and can be extremely limited in its effectiveness. In this regard, advertising content and web sites dedicated to providing information about a particular seller's goods or services must be “found” by potential customers. While practices are well-known to increase the chances that potential consumers will view a particular seller's web site, such as through registering a web site with one or more well-known search engines, such as WWW.YAHOO.COM, WWW.GOOGLE.COM, OR WWW.HOTBOT.COM, or by manipulating the content of meta tags (which are well-known in the art and comprise an invisible line of hypertext mock-up language (HTML) code which contains information about a web site) that will hopefully bring the site to a consumer's attention in response to a particular search request.

Unfortunately, however, many consumers bypass, overlook, or even try to avoid sites known to comprise primarily advertising content due to the sheer volume of advertising content currently on the Internet, not to mention most consumers' general aversion to advertising.

Such disadvantages are even more problematic for small businesses and professionals that are only capable of providing goods and/or services around a limited geographic area, and do not have capital to advertise on a national basis. Especially susceptible to such a predicament are medical practices, which virtually always require advertising and promotion for such services to be concentrated in local areas, due to the personal nature of the services rendered. Moreover, because the population base in virtually every given area is constantly changing, coupled with the changing nature by which patients need repeat or ongoing care, consistent effort to advertise and promote such services must be made to not only bring in new patients, but also keep existing patients form utilizing services provided by competitors.

While numerous web sites are now maintained by health care providers and the like that enable potential patients/consumers to obtain detailed and specific information regarding a given health care provider in a particular area, the foregoing problems still persist with respect to linking the potential consumer/patient with the information and promotional material to cause the consumer/patient to choose one provider over another. Moreover, there is lacking any readily accessible way, via the Internet, that enables health care providers and the like to directly display and promote their respective services via a single popular, nationally renown web site that is highly placed on one or more well-known search engines and further is specific in targeting potential consumer/patients centered about a specific geographic reference.

Accordingly, there is a substantial need in the art for an on-line advertising/promotion method that enables a seller, and in particular a health care provider or medical practice, to specifically direct advertising and promotional materials to potential consumer/patients that can target such consumer/patients around a particular geographic reference. There is a further need in the art for such a method that substantially increases the likelihood that a potential consumer/patient will inquire or transact business with a particular seller situated within a particular geographic region. Still further, there is a need in the art for such an on-line advertising method that can be readily implemented utilizing existing, commercially available technology.

### BRIEF SUMMARY OF THE INVENTION

The present invention specifically addresses and alleviates the above-identified deficiencies in the art. In this regard, the present invention is directed to an on-line advertising method that seeks to deliver or link advertising and promotional content of a particular seller with potential customers in and around a particular geographic reference or according to other specified criteria. The present invention is particularly well suited for the promotion and advertising by health care providers and medical practices seeking to selectively target potential patients centered around a particular geographic area.

According to a preferred embodiment, a central Internet web site is maintained that is extensively advertised and promoted about a broad geographic area, such as a continent, multiple countries, nation, multiple states or other areas of significant potential consumer demand. Such site is provided with content and is routinely maintained to thus serve as an informational resource and/or source of entertainment to thus continually draw upon and be viewed by potential consumers. To facilitate that end, conventional techniques may be utilized, such as by registering and optimizing for high placement the site with one or more search engines and the like, manipulation of the meta tag associated with the web site, as well as other techniques known in the art to obtain high search engine listing position.

The site will further be interactive with potential consumers viewing the same and will ultimately place an obligation on the potential consumer viewing the site to disclose information pertinent to the potential consumer and, preferably, information related to the geographic area about which the potential consumer is located or otherwise would be willing to transact business. Upon receipt and analysis of the data submitted by the consumer, advertising content responsive thereto will be retrieved and/or generated. To that end, a part of such site will include content data from a given database regarding various vendors and/or service providers offering their respective goods and services for sale in and around the geographic area indicated by the consumer.

Along these lines, the present invention contemplates that a fee will be paid by the venders and/or service providers to the site operator, which may preferably take the form of a subscription fee, to thus enable a particular vendor/service provider for a particular area to have its promotional content provided to the consumer supplying information indicative of the corresponding area. For example, it is contemplated that consumers providing some type of criteria, which may be a ZIP code, area code, and the like, are able to readily receive and are readily presented with detailed information regarding a particular product or service offered in that area, which may include pricing, availability, location, ordering information, or, with respect to services, the qualifications of the service provider, warranty information and the like. Furthermore, in the case of health care providers, it is contemplated that content may be provided to the consumer regarding types of insurance accepted by the health care provider, the credentials of such health care provider, any specialized training the health care provider has received, contact information regarding the health care provider, such as office hours, phone number, and the like, as well as maps indicating office location.

### BRIEF DESCRIPTION OF THE DRAWINGS

These as well as other features of the present invention will become more apparent upon reference to the drawings wherein:

FIG. 1 is a flow chart illustrating operation of the on-line advertising method according to a preferred embodiment of the present invention.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

With respect to the present invention, there is provided a method for selectively providing and distributing information and advertisements over the Internet. While the present invention as described herein is embodied in the Internet, it should be understood that the invention is not limited in this respect, and may be embodied in any data communication system wherein a content-requesting system requests data from a content server, including, but not limited to on-line information services, telephone networks, and television networks.

With respect to the Internet, the same comprises a global communications network wherein a plurality of clients interface with a plurality of content servers. Generally, content servers retrieve and/or generate content data in response to client inquiries. To that end, servers access content data stored on databases, typically associated with a particular content server.

The present invention is specifically directed to the use of such conventional content servers and databases associated therewith. Specifically, the content server and databases associated therewith provide means for controllably allowing clients to search and retrieve content data from a database associated therewith or otherwise peruse the content of advertising materials displayed upon such database or web site. Such systems and practices are well known and extensively utilized in the art.

The present invention, however, advantageously enables specific information or advertisements to be selectively provided to clients unlike other Internet databases or web sites. In this regard, the present invention is directed to the maintenance and operation of a central web site through which one or more vendors/service providers can directly provide a potential consumer viewing such web site with advertisement and promotional material that corresponds to specific criteria, which may include date such as income level, geographic location, sex, age and the like, provided by the potential consumer. As referenced herein, such vendor/service providers can comprise any seller of goods or services, including but not limited to, professional service providers. In this regard, the present invention is particularly well suited for use by health care providers, namely, physicians and the medical practices through which they operate. It should be further understood, however, that such service providers may include other professionals such as lawyers, and other trade persons of all types, such as electricians, plumbers and the like. Accordingly, it should be understood that such terms should be construed as broadly as possible.

In addition, it should be understood that the term “client” or “consumer” can mean any individual or entity to which advertisements and promotional material may be directed, and can include potential consumers, patients, or any other of a variety capable of transacting business with one or more vendors/service providers practicing the advertising methods of the present invention. Accordingly, it should be understood that such terms should likewise be construed as broadly as possible.

Bearing the foregoing in mind, the methods of the present invention are essentially intended to operate as a method for selectively targeting advertising materials wherein one or more vendors/service providers can immediately and directly display information and advertisements via a central web site, the latter of which providing informative and/or entertaining content and operative to selectively disseminate particular advertising and promotional materials in response to a client or consumer viewing such web site and providing information, which is preferably indicative of a particular geographic area.

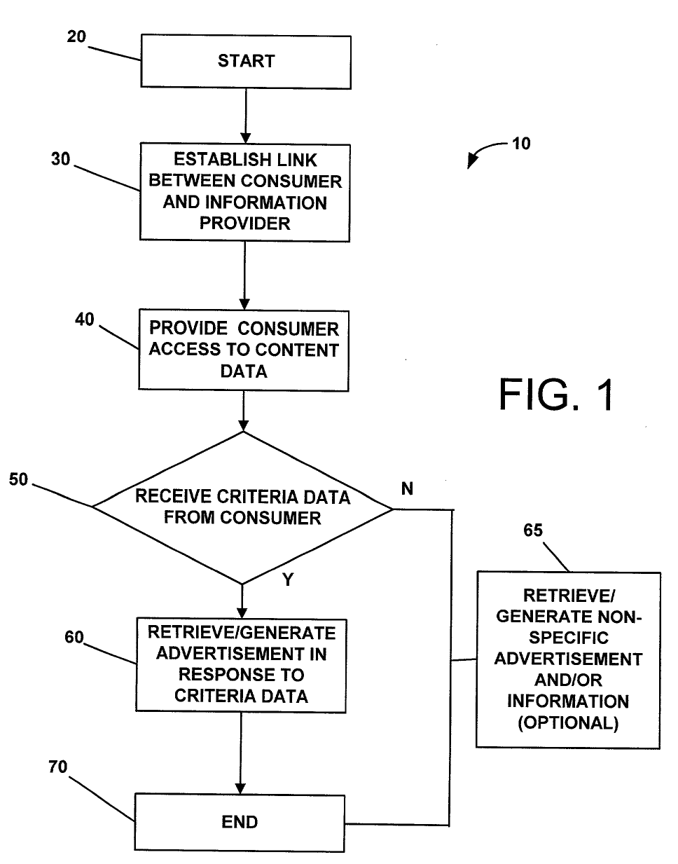

As illustrated in FIG. 1, the process 10 starts 20 by the client or consumer accessing a server or information provider 30, which will comprise an Internet web site. Once the communication link is established, the consumer is provided access to content data 40, which as will be appreciated by those skilled in the art is stored in a database associated with the server. As per conventional practices well known in the art, a consumer will thus be able to browse through the content data through any relevant areas of interest. The content data to which the consumer is allowed to access will preferably comprise informative and/or entertaining content data that will preferably be directed to a specific topic, region (for example, a particular country, region or state) or targeted group of potential consumers. As such, it will be understood that the content data will typically include general or more local information regarding a given product or service to thus convey basic information so that the consumer may make an informed basis as to whether or not to seek additional information. For example, to the extent the on-line advertising practices of the present invention are directed to the sale of consumer electronics, such as televisions, stereo equipment and the like, the content data provided in step 40 will preferably include current information on the state of consumer electronics, and may include information such as product reviews, pricing information, warranty information and the like. To facilitate the ability to search through the content data, conventional mechanisms may be incorporated into the web site, such as a search engine, which may thus search key words or terms as per conventional web site technology.

To further enhance the ability of the central web site to attract potential consumers, it will be understood and readily appreciated that such web site will preferably be registered with one or more search engines, such as WWW.GOOGLE.COM, WWW.YAHOO.COM, and WWW.HOTBOT.COM, as per conventional practices. As is known, registering web sites with such well-known search engines facilitate the ability of the web site to be found and brought to a consumer's attention via the search results produced thereby. It will further be understood that the central web site through which the methods of the present invention are practiced may deploy meta tag manipulations such that the web site is able to vie for favorable positioning in search engine indices.

Separate and apart from web site registration and manipulation, it is further contemplated that conventional advertising practices, such as television and print media may be utilized to promote the central web site. Along these lines, it is contemplated that the central web site through which the on-line advertising methods of the present invention are practiced will be promoted about a large geographic area, which may comprise a continent, one or more countries, or specific portions thereof, such as one or more cities, counties or states. It is additionally contemplated that such central web site may be heavily promoted via conventional advertising practices in densely populated areas or wherever it is believed the greatest number of potential consumers can be reached. Accordingly, any method or technique by which potential consumers are drawn a particular web site to access the content data in step 40 enhances the effectiveness of the methods of the present invention.

At some point during which the consumer accesses the content data of the web site, an obligation is placed on the consumer to disclose information indicative of the consumer to thus enable a particular advertisement from a specific vendor/service provider to be distributed, (i.e. displayed) to the consumer. It is additionally contemplated that additional information/entertainment content may be directed to the consumer which may preferably be more local in nature. Preferably, the consumer is provided with the obligation to provide information regarding the geographic area wherein the consumer lives, does business or is otherwise willing to transact business. Among such information indicative of the geographic whereabouts of the consumer include ZIP codes, area codes, or, other types of information regarding specific cities, counties and the like. It should be understood, however, that the methods of the present invention are not exclusively dependent upon geographic information, may be practiced when a client submits any demographic type of data which either identifies the consumer or enables the consumer, such as profession, income level, sex, and age, to be contacted, whether by e-mail, telephone, facsimile or any other conventional method of communication.

To the extent no information is provided by the consumer or the consumer provides faulty information, the session will end 70. Optionally, the consumer may be provided with non-specific advertising content and/or information via step 65.

Alternatively, upon receipt and analysis of the data submitted by the consumer, in step 50, the web site server will retrieve and/or generate content data of a specific/service provider which corresponds to the information, in particular the geographic data, supplied by the consumer. Such step 60 will preferably comprise advertising and information regarding a specific vendor/service provider identified in response to the geographic data provided in step 50. Such information will include the name of the vendor/service provider, as well as other pertinent information such as phone number, address, some description of services or products and the like. It is further contemplated that such information will include a link to enable the consumer to go directly to a separate web site maintained by the vendor/service provider, and likewise may include an e-mail function to enable the consumer to communicate directly with a particular vendor/service provider through the latter's web site.

The advertisement generated in step 60 may further include a map function which can enable the consumer to obtain directions to the vendor's/service provider's place of business, and may further include information as to any particular discounts, coupons, rebates, or other helpful information and such costs or savings that the vendor/service provider may wish to offer in order to entice consumers to enter into a transaction with that particular vendor/service provider. Furthermore, with respect to professional service providers, and in particular health care providers, it is contemplated that the content provided in step 60 may include types of insurance that is accepted, the credentials of such health care providers, any specialized training the health care provider may have received, office hours, and the like. It is additionally contemplated that such health care providers may be pre-screened to insure that each provider meets certain competency criteria, such as board certifications, certified licensing, status of good standing and the like. In this regard, many of the principles behind the present invention are exemplified in Applicant's web site, WWW.VASECTOMY.COM, the teachings and disclosure of which are expressly incorporated herein by reference.

Following the distribution of the advertising content to the consumer, the session ends 70. Advantageously, the on-line advertising methods of the present invention not only enable a plurality of vendors/service providers to collectively advertise through one central web site and specifically target those potential consumers in their geographic areas of business, the same further acts to potentially provide revenue for the central web site operator. As discussed above, the central web site operator may charge subscription or advertising fees and the like to enable vendors/service providers to have their respective contact information and advertisements provided to consumers visiting the central web site. It is further contemplated that a hierarchy of advertisements may be made accessible through the methods of the present invention insofar as a higher subscription fee is paid; a particular vendor/service provider is more prominently displayed or is otherwise featured as part of the regular content of such web site.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. In an arrangement comprising at least one computer network, said network connecting at least one personal computer to at least one information-provider computer, said personal computer being associated with at least one client, a method for selectively disseminating advertising materials from said information-provider to said personal computer, the method comprising:
a) establishing a communication link between said at least one personal computer to at least one information-provider computer over said network;
b) providing said at least one personal computer access to content stored within a database operatively coupled to said at least one information-provider computer;
c) placing an obligation on the client to submit criteria indicative of said client; and
d) retrieving and generating advertising materials and displaying said advertising materials across said network to said personal computer.

2. The method of claim 1 wherein in step (c), said criteria comprises a specific geographic area associated with said client and in step (d), said advertising materials correspond to advertising materials of a specific vendor or service provider conducting business in said geographic area submitted in step (c).

3. The method of claim 2 wherein in step (c), said geographic information is selected from a group of data consisting of ZIP codes, area codes, city names, county names, and state names.

4. The method of claim 1 wherein said data stored within said database comprises a listing of professional service providers operating in specified localities.

5. The method of claim 4 wherein said professional service providers comprise physicians.

6. The method of claim 4 wherein each one of said professional service providers is pre-screened to insure that each respective one of said professional service providers meet certain competency thresholds.

7. The method of claim 1 wherein said method further comprises:
a) charging a third party a fee prior to retrieving and generating said advertising materials in step (d).

8. The method of claim 7 wherein said fee comprises a subscription fee.

9. The method of claim 1 wherein said data stored within said database comprises a listing of vendors operating in specified localities.
